(19) United States
(12) Patent Application Publication
(10) Pub. No.: US 2025/0334477 A1
(43) Pub. Date: Oct. 30, 2025

(54) WIDE FRACTURE ZONE FAULT SIMULATION DEVICE WITH SEISMIC SIMULATION VIBRATION TABLE ARRAYS

(71) Applicant: JIANGHAN UNIVERSITY, Wuhan (CN)

(72) Inventors: Longjun Xu, Weihai (CN); Haoyu Wu, Wuhan (CN); Heng Zhang, Wuhan (CN); Guochen Zhao, Wuhan (CN)

(21) Appl. No.: 19/170,016

(22) Filed: Apr. 3, 2025

(30) Foreign Application Priority Data
Apr. 29, 2024 (CN) 202410525929.X

(51) Int. Cl. G01M 7/02

(52) U.S. Cl. CPC G01M 7/022

(57) ABSTRACT

Disclosed is a wide fracture zone fault simulation device with seismic simulation vibration table arrays. The device includes a left box body, a segmented box body structure, a right box body, bottom spring structures, and vibration tables. The left box body, the segmented box body structure, and the right box body are internally intercommunicated in a penetrating manner, to form a complete space for placing a soil-rock material and a civil engineering structure model required for an experiment. The segmented box body structure has freedom in X, Y, and Z directions. Under the combined action of a plurality of seismic simulation vibration table arrays, the box bodies on the segmented box body structure are dislocated in different directions to simulate seismic fault activities in a wide fault fracture zone.

### CROSS-REFERENCE TO RELATED APPLICATION

This application claims priority of Chinese Patent Application No. 202410525929.X, filed on Apr. 29, 2024, the entire contents of which are incorporated herein by reference.

### TECHNICAL FIELD

The present disclosure relates to the technical field of physical simulation devices for seismic faults, and particularly relates to a wide fracture zone fault simulation device with seismic simulation vibration table arrays.

### BACKGROUND

In a physical simulation device for simulating seismic faulting in the prior art, two box bodies filled with a soil-rock material for testing are dislocated mainly through vibration tables or a driving device, which induces damage and deformation of the soil-rock material inside the box bodies. In this way, an effect of simulating seismic faults is achieved. A width of a soil-rock fracture zone simulated by use of the physical model is relatively narrower than that obtained through a tunnel model, whereas a width of a fault fracture zone of a seismic fault in reality can be dozens of times of a tunnel diameter. Therefore, seismic fault simulation devices in the prior art cannot accurately simulate the seismic faults in a wide fault fracture zone. At present, seismic simulation vibration table arrays are power test equipment commonly used in many universities and research institutions. However, there is not a unified and feasible scheme for experimental study of cross-fault structures under the action of strong seismic fault coupling. Innovative use of the seismic simulation vibration table arrays has become a part of related researches in the art.

### SUMMARY

An objective of the present disclosure is to provide a wide fracture zone fault simulation device with seismic simulation vibration table arrays, so as to solve the problems existing in the prior art and provide a certain reference for related researches in the art in the future.

In an embodiment of the present disclosure, there is provided a wide fracture zone fault simulation device with seismic simulation vibration table arrays. The device includes a left box body, a segmented box body structure, a right box body, bottom spring structures, and vibration tables, where the left box body, the segmented box body structure, and the right box body are placed on three vibration tables closely attached to each other respectively, and the three box bodies are flush with each other in an initial state by adjusting heights of the vibration tables; the left box body and the right box body are fixedly connected to the corresponding vibration tables, and the segmented box body structure is connected to the vibration tables through the bottom spring structures; the segmented box body structure includes segmented box bodies, bottom plate structures, first springs, and canvases; the adjacent segmented box bodies are connected through the bottom plate structures and the canvases, to form the segmented box body structures; each of the bottom plate structures includes long plates, a short plate, and parallelogram hinge structures, where two of the long plates are placed in parallel, and the short plate is located at a central position of upper portions of the two long plates; and the parallelogram hinge structures are arranged at middle positions of bottoms of the two long plates, and the long plates and the short plate are connected through the parallelogram hinge structures to form the bottom plate structures.

Further, the left box body, the segmented box body structure, and the right box body are internally intercommunicated in a penetrating manner, to form a larger overall space.

Further, the left box body is a non-enclosed box body, openings are formed on a side edge in an X direction and at a top of the left box body, and a soil-rock space is arranged inside the left box body; a convex edge is arranged at the opening on the side edge of the left box body, and the right box body is arranged symmetrically with the left box body in the X-direction; openings are formed on two sides and a top of the segmented box body structure, and convex edges are arranged at the openings on two sides thereof respectively; and a soil-rock space is arranged in the segmented box body structure.

Further, each of the bottom plate structures is located at a middle position between two adjacent segmented box bodies, and arranged at a bottom of inner sides of the two segmented box bodies; the segmented box bodies are connected to the bottom plate structures through a plurality of the first springs; and ends of the first springs are fixedly connected to inner bottom faces of the segmented box bodies and the long plates in the bottom plate structures.

Further, a length of each of the long plates is kept consistent with an internal width of each of the segmented box bodies, a thickness and a width of the short plate are consistent with those of each of the long plates, but a length of the short plate is less than that of each of the long plates; and a difference in length between the long plates and the short plate is a distance by which a plurality of the segmented box bodies are maybe dislocated in a Y direction.

Further, each of the parallelogram hinge structures is formed by a plurality of elongated steel bars, and the plurality of elongated steel bars are connected to each other in a parallel and intersecting manner to form a parallelogram; inside the parallelogram, steel bars with a same length as a side length of the parallelogram are arranged in a parallel manner; and holes formed at ends of each of the steel bars, and the steel bars penetrate through the holes through pin shafts to form the parallelogram hinge structures.

Further, each of the bottom spring structures includes second springs and spherical casters, ends of each of the second springs are fixedly connected to a bottom of one of the segmented box bodies and one of the spherical casters, respectively; and the spherical casters are placed on the vibration tables, and the spherical casters are capable of moving freely in X and Y directions of the vibration tables.

The beneficial effects of the present disclosure are as follows: during the operation of the vibration tables, the second springs in the bottom spring structures have freedom in a Z direction, and the spherical casters have the freedom in the X and Y directions. The bottom spring structures allow the segmented box body structure to have the freedom in the X, Y, and Z directions, and in combination with the bottom plate structures, the bottom spring structures enable a plurality of the segmented box bodies to be dislocated in the X, Y, and Z directions under the action of the vibration tables. The seismic fault simulation device of the present disclosure is used for simulating various types of seismic fault activities in reality, greatly enhancing simulation capability and accuracy. The bottom plate structures are capable of moving freely in cooperation with the segmented box bodies, and in combination with the canvas, block a loss of a soil-rock material between the box bodies during an experiment, without affecting the dislocation between the segmented box bodies in a plurality of directions, thereby improving accuracy of experimental results as much as possible.

### BRIEF DESCRIPTION OF THE DRAWINGS

FIG. 1 is a schematic diagram of the present disclosure (including a vibration table) in a coordinate system.

FIG. 2 is a side view of the present disclosure (including a vibration table).

FIG. 3 is a top view of the present disclosure (including a vibration table).

FIG. 4 is a three-dimensional model diagram of a segmented box body structure.

FIG. 5 is a front view of a segmented box body structure.

FIG. 6 is a three-dimensional model diagram of a bottom plate structure.

FIG. 7 is a bottom view of a bottom plate structure.

In the figures:

10. left box body; 20. segmented box body structure; 30. right box body; 40. bottom spring structure; 50. vibration table; 21. segmented box body; 22. bottom plate structure; 23. first spring; 24. canvas; 221. long plate; 222. short plate; 223. parallelogram hinge structure; 2231. steel bar; 41. second spring; and 42. spherical caster.

### DETAILED DESCRIPTIONS OF THE EMBODIMENTS

The technical solutions in the examples of the present disclosure will be clearly and completely described below with reference to the accompanying drawings in the examples of the present disclosure. Obviously, the described examples are merely some examples rather than all examples of the present disclosure. All the other examples obtained by those of ordinary skill in the art based on the examples in the present disclosure without creative efforts shall fall within the scope of protection of the present disclosure.

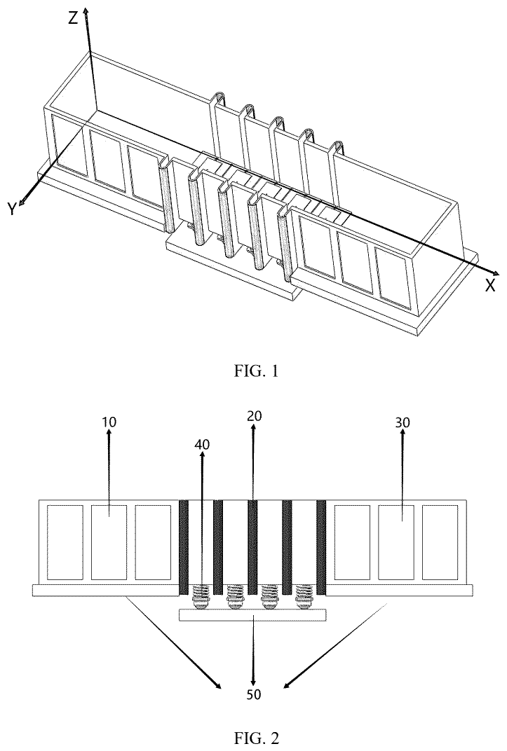

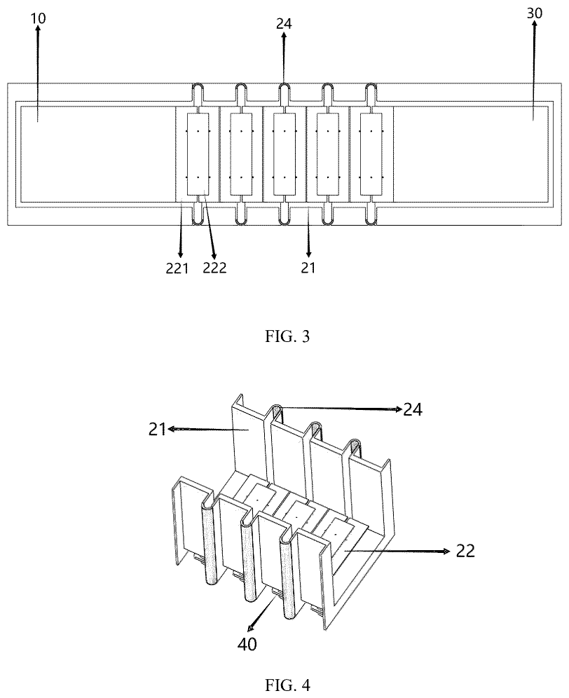

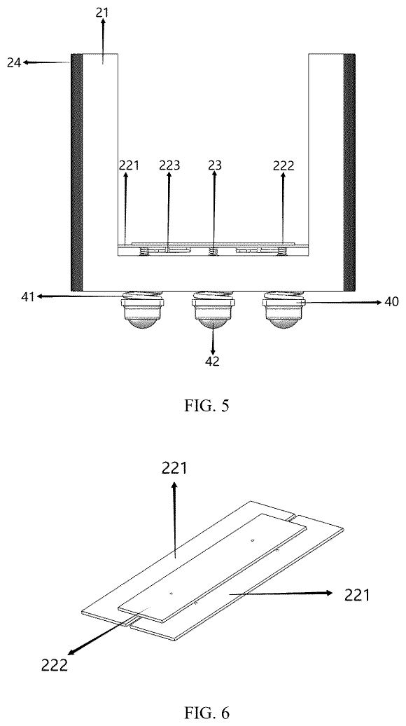

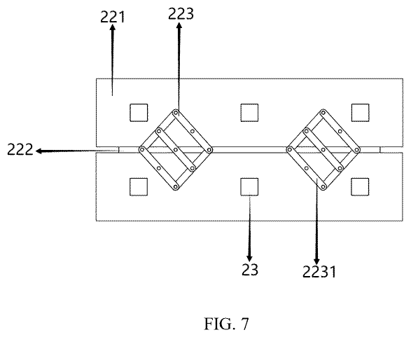

As illustrated in FIGS. 1-3, a wide fracture zone fault simulation device with seismic simulation vibration table arrays includes a left box body 10, a segmented box body structure 20, a right box body 30, bottom spring structures 40, and vibration tables 50, where the left box body 10, the segmented box body structure 20, and the right box body 30 are placed on three vibration tables 50 closely attached to each other respectively, and the three box bodies are flush with each other in an initial state by adjusting heights of the vibration tables 50. The left box body 10 and the right box body 30 are fixedly connected to the corresponding vibration tables 50 respectively, and the segmented box body structure 20 is connected to the vibration tables 50 through the bottom spring structures 40. As illustrated in FIGS. 4 and 5, the segmented box body structure 20 includes segmented box bodies 21, bottom plate structures 22, first springs 23, and canvases 24. The adjacent segmented box bodies 21 are connected through the bottom plate structures 22 and the canvases 24, such that the segmented box body structure 20 can undergo various deformations with operation of the vibration tables 50 during an experiment, thereby simulating various forms of seismic fault activities. As illustrated in FIG. 6, each of the bottom plate structures 22 includes long plates 221, a short plate 222, and parallelogram hinge structures 223. As illustrated in FIG. 7, two of the long plates 221 are placed in parallel, and the short plate 222 is located at a central position of upper portions of the two long plates 221. The parallelogram hinge structures 223 are arranged at middle positions of bottoms of the two long plates 221, and the long plates 221 and the short plate 222 are connected through the parallelogram hinge structures 223 to form the bottom plate structures 22. The bottom plate structures 22 are maybe dislocated to a certain extent in X and Y directions to match various dislocation directions between a plurality of the segmented box bodies 21.

The left box body 10, the segmented box body structure 20, and the right box body 30 are internally intercommunicated in a penetrating manner, to form a larger overall space, and the space is used for placing an experimental soil-rock material. Before an experiment, a soil-rock material and a corresponding civil engineering structure model are placed in the overall space. The operation of the vibration tables 50 drives the left box body 10, the segmented box body structure 20 and the right box body 30 to be dislocated to a certain extent, which further causes the dislocation and deformation of the soil-rock material inside the box bodies. In particular, the experimental soil-rock material in the segmented box body structure 20 will cause seismic fault activities in a wide fault fracture zone, thereby significantly enhancing a simulation effect of the seismic fault simulation device.

The left box body 10 is a non-enclosed box body, openings are formed on a side edge in the X direction and at a top of the left box body 10, and a soil-rock space is arranged inside the left box body 10. A convex edge is arranged at the opening on the side edge of the left box body 10, and the right box body 30 is arranged symmetrically with the left box body 10 in the X-direction. Openings are formed on two sides and a top of the segmented box body structure 20, and convex edges are arranged at the openings on two sides thereof respectively. A soil-rock space is arranged in the segmented box body structure 20. The soil-rock space is used to place the experimental soil-rock material required for the experiment, and the convex edges are configured for preventing significant loss of the soil-rock material in the box bodies caused by dislocation between the box bodies, so as to avoid affecting experimental results.

Each of the bottom plate structures 22 is located at a middle position between two adjacent segmented box bodies 21, and arranged at a bottom of inner sides of the two segmented box bodies 21. The segmented box bodies 21 are connected to the bottom plate structures 22 through a plurality of the first springs 23. Ends of the first springs 23 are fixedly connected to inner bottom faces of the segmented box bodies 21 and the long plates 221 in the bottom plate structures 22. The plurality of the first springs 23 are spaced apart from each other in the Y direction. The first springs 23 are capable of causing a certain degree of stretching and compression in a Z direction. When a certain degree of dislocation between the segmented box bodies 21 in the Z direction is caused by the operation of the vibration tables 50, normal operation of the bottom plate structure 22 is ensured, such that a movement trajectory of the segmented box bodies 21 is not limited in the X and Y directions by the parallelogram hinge structures 223.

A length of each of the long plates 221 is kept consistent with an internal width of each of the segmented box bodies 21, such that the long plates 221 can be placed at bottoms of the segmented box bodies 21. A thickness and a width of the short plate 222 are consistent with those of each of the long plates 221, but a length of the short plate 222 is less than that of each of the long plates 221. A difference in length between the long plates 221 and the short plate 222 is a distance by which a plurality of the segmented box bodies 21 are maybe dislocated in the Y direction.

Each of the parallelogram hinge structures 223 is formed by a plurality of elongated steel bars 2231, and the plurality of elongated steel bars 2231 are connected to each other in a parallel and intersecting manner to form a parallelogram. Inside the parallelogram, steel bars with a same length as a side length of the parallelogram are arranged in a parallel manner. Holes formed at ends of each of the steel bars 2231, and the steel bars 2231 penetrate through the holes through pin shafts to form the parallelogram hinge structures 223. The pin shafts allow relative rotation between the steel bars 2231, such that the parallelogram hinge structures 223 are capable of stretching or retracting in a plurality of directions, thereby meeting the requirements for relative dislocation of the long plates 221 and the short plate 222 thereon. The number of steel bars shown in FIG. 7 is illustrative, which can be adjusted as needed in practical applications, provided that a final pattern formed by the steel bars is a parallelogram to allow for the deformation.

Each of the bottom spring structures 40 includes second springs 41 and spherical casters 42. Ends of each of the second springs 41 are fixedly connected to a bottom of one of the segmented box bodies 21 and one of the spherical casters 42, respectively. The spherical casters 42 are placed on the vibration tables, and the spherical casters 42 are capable of moving freely in X and Y directions of the vibration tables. A bottom of each of the segmented box bodies 21 is fixedly connected to an equal number of the bottom spring structures 40, and the bottom spring structures 40 are spaced from each other in the Y direction. A plurality of the second springs 41 are arranged, such that the segmented box bodies 21 are capable of moving in the Z direction with the operation of the vibration tables during the experiment. The bottom spring structures 40 provide sufficient freedom for the segmented box bodies 21 under the action of the vibration tables, to match the dislocation and deformation of the soil-rock material in the box bodies, so as to simulate more realistic seismic fault activities in the wide fault fracture zone.

The number of the segmented box bodies 21 depends on specific experimental research objectives. Since a certain distance of dislocation between every two of the segmented box bodies 21 exists, the number of the segmented box bodies 21 determines a maximum scale of the fault fracture zone generated by the seismic fault activities simulated in the experiment. Experimenters can set the number of the segmented box bodies 21 according to specific circumstances at their own discretion. The plurality of the segmented box bodies 21 are arranged and connected in the X direction.

During the experiment, the dislocation in a plurality of directions will occur between the plurality of the segmented box bodies 21 and between the segmented box bodies 21, the left box body 10 and the right box body 30. When the dislocation between the box bodies occurs in the X direction, the bottom plate structures 22 and the canvases 24 will deform accordingly in the X direction to partially block the loss of the soil-rock material in the box bodies. When the dislocation between the box bodies occurs in the Y and Z directions, the convex edges at the openings of the box bodies will block the loss of the soil-rock material in the box bodies, and both the bottom plate structures 22 and the bottom spring structures 40 will deform accordingly to meet the experimental requirements.

For those skilled in the art, it is apparent that the present disclosure is not limited to the details of the above-mentioned exemplary examples, and the present disclosure may be implemented in other specific forms without departing from the spirit or basic features of the present disclosure. Therefore, the embodiments are to be regarded as illustrative and non-restrictive no matter from which point of view. The scope of the present disclosure is defined by the appended claims rather than the above specification, and therefore, it is intended that all changes which fall within the meaning and scope of equivalency of the claims are embraced in the present disclosure. Any reference numeral in the claims is not to be construed as limiting the related claims.

1. A wide fracture zone fault simulation device with seismic simulation vibration table arrays, comprising a left box body, a segmented box body structure, a right box body, bottom spring structures, and vibration tables, wherein the left box body, the segmented box body structure, and the right box body are placed on three vibration tables closely attached to each other, and the three box bodies are flush with each other in an initial state by adjusting heights of the vibration tables; the left box body and the right box body are fixedly connected to the corresponding vibration tables, and the segmented box body structure is connected to the vibration tables through the bottom spring structures; the segmented box body structure comprises segmented box bodies, bottom plate structures, first springs, and canvases; the adjacent segmented box bodies are connected through the bottom plate structures and the canvases, to form the segmented box body structures; each of the bottom plate structures comprises long plates, a short plate, and parallelogram hinge structures, wherein two of the long plates are placed in parallel, and the short plate is located at a central position of upper portions of the two long plates; and the parallelogram hinge structures are arranged at middle positions of bottoms of the two long plates, and the long plates and the short plate is connected through the parallelogram hinge structures to form the bottom plate structures.

2. The wide fracture zone fault simulation device with seismic simulation vibration table arrays according to claim 1, wherein the left box body, the segmented box body structure, and the right box body are internally intercommunicated in a penetrating manner, to form a larger overall space.

3. The wide fracture zone fault simulation device with seismic simulation vibration table arrays according to claim 2, wherein the left box body is a non-enclosed box body, openings are formed on a side edge in an X direction and at a top of the left box body, and a soil-rock space is arranged inside the left box body; a convex edge is arranged at the opening on the side edge of the left box body, and the right box body is arranged symmetrically with the left box body in the X-direction; openings are formed on two sides and a top of the segmented box body structure, and convex edges are arranged at the openings on two sides thereof, and a soil-rock space is arranged in the segmented box body structure.

4. The wide fracture zone fault simulation device with seismic simulation vibration table arrays according to claim 1, wherein each of the bottom plate structures is located at a middle position between two adjacent segmented box bodies, and arranged at a bottom of inner sides of the two segmented box bodies; the segmented box bodies are connected to the bottom plate structures through a plurality of the first springs; and ends of the first springs are fixedly connected to inner bottom faces of the segmented box bodies and the long plates in the bottom plate structures.

5. The wide fracture zone fault simulation device with seismic simulation vibration table arrays according to claim 4, wherein a length of each of the long plates is kept consistent with an internal width of each of the segmented box bodies, a thickness and a width of the short plate are consistent with those of each of the long plates, but a length of the short plate is less than that of each of the long plates; and a difference in length between the long plates and the short plate is a distance by which a plurality of the segmented box bodies are maybe dislocated in a Y direction.

6. The wide fracture zone fault simulation device with seismic simulation vibration table arrays according to claim 1, wherein each of the parallelogram hinge structures is formed by a plurality of elongated steel bars, and the plurality of elongated steel bars are connected in a parallel and intersecting manner to form a parallelogram; inside the parallelogram, steel bars with a same length as a side length of the parallelogram are arranged in a parallel manner; and holes formed at ends of each of the steel bars, and the steel bars penetrate through the holes through pin shafts to form the parallelogram hinge structures.

7. The wide fracture zone fault simulation device with seismic simulation vibration table arrays according to claim 1, wherein each of the bottom spring structures comprises second springs and spherical casters, ends of each of the second springs are fixedly connected to a bottom of one of the segmented box bodies and one of the spherical casters; and the spherical casters are placed on the vibration tables, and the spherical casters are capable of moving freely in X and Y directions of the vibration tables.
